(19) United States
(12) Patent Application Publication
(10) Pub. No.: US 2026/0221650 A1
(43) Pub. Date: Jul. 30, 2026

(54) BASE STATION ANTENNA AND COMMUNICATION DEVICE

(71) Applicant: HUAWEI TECHNOLOGIES CO., LTD., Shenzhen (CN)

(72) Inventors: Zijing Du, Xi'an (CN); Dingjiu Daojian, Dongguan (CN); Weihong Xiao, Dongguan (CN); Shulin Wang, Dongguan (CN); Xiaogang Xue, Dongguan (CN)

(73) Assignee: HUAWEI TECHNOLOGIES CO., LTD., Shenzhen (CN)

(21) Appl. No.: 19/573,719

(22) Filed: Mar. 20, 2026

Related U.S. Application Data
(63) Continuation of application No. PCT/CN2024/119866, filed on Sep. 19, 2024.

(30) Foreign Application Priority Data
Sep. 21, 2023 (CN) 202311228976.X

(51) Int. Cl. H01Q 3/04; H01Q 1/24; H01Q 21/00

(52) U.S. Cl. CPC H01Q 3/04; H01Q 1/246; H01Q 21/0075

(57) ABSTRACT

Embodiments of this application provide a base station antenna and a communication device. The base station antenna includes at least one antenna array. The at least one antenna array includes a stripline and at least one radiating element. The stripline includes a stripline inner conductor and a cavity that is configured to accommodate the stripline inner conductor. The at least one radiating element is fastened to an outer surface of the cavity. The cavity in the at least one antenna array is configured to receive a driving force output by a driving member. When the cavity receives the driving force, the antenna array corresponding to the cavity rotates around a rotation axis parallel to a length direction of the stripline. The base station antenna and the communication device that are provided in embodiments of this application can flexibly adjust an azimuth of an antenna array to meet a use requirement.

### CROSS-REFERENCE TO RELATED APPLICATIONS

This application is a continuation of International Application No. PCT/CN2024/119866, filed on September 19, 2024, which claims priority to Chinese Patent Application No. 202311228976.X, filed on September 21, 2023. The disclosures of the aforementioned applications are hereby incorporated by reference in their entireties.

### TECHNICAL FIELD

Embodiments of this application relate to the field of antenna technologies, and in particular, to a base station antenna and a communication device.

### BACKGROUND

An electromagnetic signal coverage area in mobile communication is implemented by installing a base station antenna at a base station and enabling a beam of the base station antenna to cover the region. When a geographical feature, user distribution, and the like of the region change, a beam radiation direction of the base station antenna needs to be adjusted, so that the electromagnetic signal re-covers the changed region. In a related technology, a mechanical apparatus is disposed on a mounting bracket that bears a base station antenna to drive the entire base station antenna to rotate mechanically in a horizontal direction, so as to change a physical location of the entire base station antenna, and further change an azimuth of the entire base station antenna.

### SUMMARY

Embodiments of this application provide a base station antenna and a communication device, so that an azimuth of an antenna array can be flexibly adjusted to meet a use requirement.

A first aspect of this application provides a base station antenna, including at least one antenna array. The at least one antenna array includes a stripline and at least one radiating element. The stripline includes a stripline inner conductor and a cavity that is configured to accommodate the stripline inner conductor. The at least one radiating element is fastened to an outer surface of the cavity. The cavity in the at least one antenna array is configured to receive a driving force output by a driving member. When the cavity receives the driving force, the antenna array corresponding to the cavity rotates around a rotation axis parallel to a length direction of the stripline.

In the base station antenna provided in this embodiment of this application, the cavity in the at least one antenna array receives the driving force output by the driving member, so that a single antenna array can independently rotate around the rotation axis. In this way, an azimuth of the single antenna array can be independently adjusted, and a use requirement can be met.

In a possible implementation, the at least one radiating element includes a radiating portion configured to separately electrically connect to the stripline inner conductor and the cavity. The radiating portion includes a plurality of layer structures arranged side by side at intervals along a first direction. The plurality of layer structures are configured to directionally radiate an electromagnetic signal along the first direction away from the stripline. The first direction intersects and does not overlap a length direction of the stripline.

The radiating portion of the radiating element in the base station antenna provided in this embodiment of this application includes the plurality of layer structures, so that not only the electromagnetic signal can be directionally radiated a corresponding region along the first direction, but also a weight of the base station antenna can be reduced to implement a lightweight design.

In a possible implementation, the at least one antenna array includes a plurality of radiating elements. In the same antenna array, the plurality of radiating elements are arranged side by side at intervals along the length direction of the stripline; or in the same antenna array, the plurality of radiating elements are arranged side by side along the length direction of the stripline, two adjacent layer structures are an integrated structure, and the two adjacent layer structures respectively belong to two adjacent radiating elements in at least two radiating elements.

In the same antenna array of the base station antenna provided in this embodiment of this application, any two radiating portions do not share a same layer structure or at least some radiating portions share a same layer structure, so that an electromagnetic signal can be radiated to a corresponding region, thereby meeting a use requirement. However, when radiating portions of at least two radiating elements in the same antenna array are independent of each other, the weight of the base station antenna can be further reduced, thereby implementing an ultimate lightweight design.

In a possible implementation, the at least one radiating element further includes a feeding portion, a first end of the feeding portion is fastened to the outer surface of the cavity, and the radiating portion is fastened to a second end of the feeding portion and is separately electrically connected to the stripline inner conductor and the cavity through the feeding portion.

The radiating portion in the base station antenna provided in this embodiment of this application is connected to the stripline through the feeding portion, so that not only the radiating portion can be fastened to the outer surface of the cavity to simplify a structure of the antenna array, but also the radiating portion can be separately electrically connected to the cavity and the stripline inner conductor to reduce a loss.

In a possible implementation, the feeding portion includes a feeding inner core and a feeding outer conductor, a first end of the feeding outer conductor is fastened to the outer surface of the cavity and is electrically connected to the cavity, the radiating portion is connected to a second end of the feeding outer conductor and is electrically connected to the feeding outer conductor, and the radiating portion is electrically connected to the stripline inner conductor through the feeding inner core.

The feeding portion in the base station antenna provided in this embodiment of this application includes the feeding outer conductor and the feeding inner core, so that not only the radiating portion can be fastened to the outer surface of the cavity, but also the radiating portion can be separately electrically connected to the stripline inner conductor and the cavity, thereby implementing a low-loss design.

In a possible implementation, the cavity in the at least one antenna array includes a plurality of accommodation cavity segments extending along the length direction of the stripline; and in the same cavity, areas of radial cross-sections of at least two accommodation cavity segments are different along the length direction of the stripline, and the radial cross-section of the accommodation cavity segment is perpendicular to the length direction of the stripline.

The base station antenna provided in this embodiment of this application includes at least two accommodation cavity segments with different areas of radial cross-sections, so that a weight of the cavity is reduced, thereby reducing a weight of the antenna array, and further reducing a weight of the base station antenna.

In a possible implementation, the cavity in the at least one antenna array is configured to define at least one accommodation cavity, and the stripline of the at least one antenna array includes at least one stripline inner conductor; in the same antenna array, the at least one accommodation cavity is in one-to-one correspondence with the at least one stripline inner conductor, and the stripline inner conductor is disposed inside the corresponding accommodation cavity; and when the cavity defines a plurality of accommodation cavities, the plurality of accommodation cavities are arranged side by side along a direction perpendicular to the length direction of the stripline, and two adjacent accommodation cavities share one side wall.

The cavity in the base station antenna provided in this embodiment of this application defines at least one accommodation cavity in one-to-one correspondence with at least one stripline inner conductor, so that the stripline can be electrically connected to a radiating element having at least one polarization direction.

In a possible implementation, the stripline of the at least one antenna array further includes at least one movable member, the at least one movable member is in one-to-one correspondence with the at least one accommodation cavity, and each movable member is disposed inside the corresponding accommodation cavity; and the movable member includes a dielectric member configured to slide relative to the stripline inner conductor along the length direction of the stripline; or the movable member includes a metal member configured to slide along the length direction of the stripline and configured to couple to the stripline inner conductor.

According to the base station antenna provided in this embodiment of this application, the movable member moving along the length direction of the stripline is disposed in the accommodation cavity. When the movable member is located at different positions in the accommodation cavity along the length direction of the stripline, a phase of an electromagnetic signal radiated by the radiating element can be changed, so that a maximum direction of the electromagnetic signal radiated by the radiating element is changed, and further a downtilt angle of the antenna array can be adjusted.

In a possible implementation, the radiating element is a single-polarized radiating element or a dual-polarized radiating element; and when the radiating element is the single-polarized radiating element, the single-polarized radiating element is configured to separately electrically connect to the cavity and one stripline inner conductor; or when the radiating element is the dual-polarized radiating element, the dual-polarized radiating element is configured to separately electrically connect to the cavity and two stripline inner conductors.

In a possible implementation, the base station antenna includes a plurality of antenna arrays, rotation axes of any two antenna arrays are parallel to each other, and rotation directions of at least two antenna arrays are the same.

The rotation directions of the at least two antenna arrays in the base station antenna provided in this embodiment of this application are the same, so that it can be ensured that a single antenna array meets a corresponding use requirement.

In a possible implementation, the base station antenna includes the plurality of antenna arrays; and the at least two antenna arrays rotate simultaneously; or the plurality of antenna arrays do not rotate simultaneously.

The plurality of antenna arrays in the base station antenna provided in this embodiment of this application do not rotate simultaneously, or the at least two antenna arrays rotate simultaneously, so that an azimuth of a corresponding antenna array can be adjusted based on the use requirement.

In a possible implementation, the base station antenna includes the plurality of antenna arrays; and operating frequency bands of the at least two antenna arrays are different; or operating frequency bands of the plurality of antenna arrays are the same.

The operating frequency bands of the plurality of antenna arrays in the base station antenna provided in this embodiment of this application are the same, or the operating frequency bands of the at least two antenna arrays are different, so that a use requirement of a user can be met.

In a possible implementation, the base station antenna further includes a plurality of first transmission members, the plurality of first transmission members are in one-to-one correspondence with the plurality of antenna arrays, and the first transmission member is configured to drivingly connect the driving member and the cavity of the corresponding antenna array.

According to the base station antenna provided in this embodiment of this application, the driving force output by the driving member is transferred to the plurality of antenna arrays by using the first transmission member, so that not only at least one antenna array can rotate independently to adjust an azimuth of a single antenna array, but also a time at which the single antenna array rotates can be controlled to meet a use requirement.

In a possible implementation, the base station antenna further includes the driving member, the driving member is drivingly connected to the cavity of the at least one antenna array, and the driving member is configured to drive the at least one antenna array to rotate around the rotation axis.

In a possible implementation, the base station antenna includes the plurality of antenna arrays, the plurality of antenna arrays are arranged side by side at intervals along a second direction, and the second direction intersects and does not overlap either the first direction or the length direction of the stripline.

A second aspect of this application provides a base station antenna, including at least one antenna array. The at least one antenna array includes a stripline and at least one radiating element; the at least one radiating element is fastened to an outer surface of the stripline; and the at least one radiating element includes a radiating portion electrically connected to the stripline, the radiating portion includes a plurality of layer structures arranged side by side at intervals along a first direction, the plurality of layer structures are configured to directionally radiate an electromagnetic signal along the first direction away from the stripline, and the first direction intersects and does not overlap a length direction of the stripline.

The radiating portion of the radiating element of the base station antenna provided in this embodiment of this application includes the plurality of layer structures, so that the radiating portion can directionally radiate the electromagnetic signal to a corresponding region after receiving the electromagnetic signal transferred by the stripline, in other words, the electromagnetic signal radiated by the radiating portion is not in contact with the stripline. Therefore, by radiating the electromagnetic signal by the radiating portion including the plurality of layer structures, a reflection panel may not need to be separately disposed in the base station antenna, thereby reducing a weight of the base station antenna, and further implementing a lightweight design.

In a possible implementation, the stripline includes a cavity and a stripline inner conductor that is disposed inside the cavity and that extends along the length direction of the stripline; and in the same the antenna array, the at least one radiating element is connected to an outer surface of the cavity, and the radiating portion of the at least one radiating element is separately electrically connected to the cavity and the stripline inner conductor.

The radiating portion of the radiating element in the base station antenna provided in this embodiment of this application is separately electrically connected to the stripline inner conductor and the cavity, so that a loss can be reduced, and antenna performance can be ensured.

In a possible implementation, the at least one antenna array includes a plurality of radiating elements; in the same antenna array, the plurality of radiating elements are arranged side by side at intervals along the length direction of the stripline; or in the same antenna array, the plurality of radiating elements are arranged side by side along the length direction of the stripline, two adjacent layer structures are an integrated structure, and the two adjacent layer structures respectively belong to two adjacent radiating elements in at least two radiating elements.

In the same antenna array of the base station antenna provided in this embodiment of this application, any two radiating portions do not share a same layer structure or at least some radiating portions share a same layer structure, so that an electromagnetic signal can be radiated to a corresponding region, thereby meeting a use requirement. However, when radiating portions of at least two radiating elements in the same antenna array are independent of each other, the weight of the base station antenna can be further reduced, thereby implementing an ultimate lightweight design.

In a possible implementation, the cavity in the at least one antenna array is configured to receive a driving force output by a driving member. When the cavity receives the driving force, the antenna array corresponding to the cavity rotates around a rotation axis parallel to the length direction of the stripline.

According to the base station antenna provided in this embodiment of this application, the cavity receives the driving force output by the driving member, so that a single antenna array rotates independently, thereby adjusting an azimuth of the single antenna array, and further meeting a use requirement.

In a possible implementation, the at least one radiating element further includes a feeding portion, a first end of the feeding portion is fastened to the outer surface of the cavity, and the radiating portion is fastened to a second end of the feeding portion and is separately electrically connected to the stripline inner conductor and the cavity through the feeding portion.

The radiating portion in the base station antenna provided in this embodiment of this application is connected to the stripline through the feeding portion, so that not only the radiating portion can be fastened to the outer surface of the cavity to simplify a structure of the antenna array, but also the radiating portion can be separately electrically connected to the cavity and the stripline inner conductor to reduce a loss.

In a possible implementation, the feeding portion includes a feeding inner core and a feeding outer conductor, a first end of the feeding outer conductor is fastened to the outer surface of the cavity and is electrically connected to the cavity, the radiating portion is connected to a second end of the feeding outer conductor and is electrically connected to the feeding outer conductor, and the radiating portion is electrically connected to the stripline inner conductor through the feeding inner core.

The feeding portion in the base station antenna provided in this embodiment of this application includes the feeding outer conductor and the feeding inner core, so that not only the radiating portion can be fastened to the outer surface of the cavity, but also the radiating portion can be separately electrically connected to the stripline inner conductor and the cavity, thereby implementing a low-loss design.

In a possible implementation, the cavity in the at least one antenna array includes a plurality of accommodation cavity segments extending along the length direction of the stripline; and in the same cavity, areas of radial cross-sections of at least two accommodation cavity segments are different along the length direction of the stripline, and the radial cross-section of the accommodation cavity segment is perpendicular to the length direction of the stripline.

The base station antenna provided in this embodiment of this application includes at least two accommodation cavity segments with different areas of radial cross-sections, so that a weight of the cavity is reduced, thereby reducing a weight of the antenna array, and further reducing a weight of the base station antenna.

In a possible implementation, the cavity in the at least one antenna array is configured to define at least one accommodation cavity, and the stripline of the at least one antenna array includes at least one stripline inner conductor; in the same antenna array, the at least one accommodation cavity is in one-to-one correspondence with the at least one stripline inner conductor, and the stripline inner conductor is disposed inside the corresponding accommodation cavity; and when the cavity defines a plurality of accommodation cavities, the plurality of accommodation cavities are arranged side by side along a direction perpendicular to the length direction of the stripline, and two adjacent accommodation cavities share one side wall.

The cavity in the base station antenna provided in this embodiment of this application defines at least one accommodation cavity in one-to-one correspondence with at least one stripline inner conductor, so that the stripline can be electrically connected to a radiating element having at least one polarization direction.

In a possible implementation, the stripline of the at least one antenna array further includes at least one movable member, the at least one movable member is in one-to-one correspondence with the at least one accommodation cavity, and each movable member is disposed inside the corresponding accommodation cavity; and the movable member includes a dielectric member configured to slide relative to the stripline inner conductor along the length direction of the stripline; or the movable member includes a metal member configured to slide along the length direction of the stripline and configured to couple to the stripline inner conductor.

According to the base station antenna provided in this embodiment of this application, the movable member moving along the length direction of the stripline is disposed in the accommodation cavity. When the movable member is located at different positions in the accommodation cavity along the length direction of the stripline, a phase of an electromagnetic signal radiated by the radiating element can be changed, so that a maximum direction of the electromagnetic signal radiated by the radiating element is changed, and further a downtilt angle of the antenna array can be adjusted.

In a possible implementation, the radiating element is a single-polarized radiating element or a dual-polarized radiating element; and when the radiating element is the single-polarized radiating element, the single-polarized radiating element is configured to separately electrically connect to the cavity and one stripline inner conductor; or when the radiating element is the dual-polarized radiating element, the dual-polarized radiating element is configured to separately electrically connect to the cavity and two stripline inner conductors.

In a possible implementation, the base station antenna includes a plurality of antenna arrays, rotation axes of any two antenna arrays are parallel to each other, and rotation directions of at least two antenna arrays are the same.

In a possible implementation, the base station antenna includes the plurality of antenna arrays; and the at least two antenna arrays rotate simultaneously; or the plurality of antenna arrays do not rotate simultaneously.

In a possible implementation, the base station antenna includes the plurality of antenna arrays; and operating frequency bands of the at least two antenna arrays are different; or operating frequency bands of the plurality of antenna arrays are the same.

In a possible implementation, the base station antenna further includes a plurality of first transmission members, the plurality of first transmission members are in one-to-one correspondence with the plurality of antenna arrays, and the first transmission member is configured to drivingly connect the driving member and the cavity of the corresponding antenna array.

According to the base station antenna provided in this embodiment of this application, the driving force output by the driving member is transferred to the plurality of antenna arrays by using the first transmission member, so that not only at least two antenna arrays can rotate independently to adjust an azimuth of a single antenna array, but also a time at which the single antenna array rotates can be controlled to meet a use requirement.

In a possible implementation, the base station antenna further includes the driving member, the driving member is drivingly connected to the cavity of the at least one antenna array, and the driving member is configured to drive the at least one antenna array to rotate around the rotation axis.

In a possible implementation, the base station antenna includes the plurality of antenna arrays, the plurality of antenna arrays are arranged side by side at intervals along a second direction, and the second direction intersects and does not overlap either the first direction or the length direction of the stripline.

A third aspect of this application provides a communication device, including the base station antenna according to the first aspect or the second aspect.

### BRIEF DESCRIPTION OF DRAWINGS

FIG. 1 is a diagram of a structure of a base station antenna in a related technology;

FIG. 2 is a diagram of a structure of a communication device according to an embodiment of this application;

FIG. 3 is a sectional view of a first base station antenna according to an embodiment of this application;

FIG. 4 is a diagram of a partial structure of a second base station antenna according to an embodiment of this application;

FIG. 5 is a partial sectional view of a single antenna array in FIG. 4 in cooperation with a driving member;

FIG. 6 is a partial sectional view of the antenna array in FIG. 5;

FIG. 7 is a diagram of a structure of a base station antenna having a plurality of operating frequency bands according to an embodiment of this application;

FIG. 8 is a diagram of a second structure that is different from that in FIG. 5 and in which a driving member is drivingly connected to an antenna array according to an embodiment of this application;

FIG. 9 is a diagram of a third structure in which a driving member is drivingly connected to a plurality of antenna arrays according to an embodiment of this application;

FIG. 10 is a diagram of a fourth structure in which a driving member is drivingly connected to a plurality of antenna arrays according to an embodiment of this application;

FIG. 11 is a transverse sectional view of a cavity in FIG. 5;

FIG. 12 is a transverse sectional view of another cavity according to an embodiment of this application;

FIG. 13 is a diagram of a structure of an antenna array of a third base station antenna according to an embodiment of this application;

FIG. 14 is a diagram of a structure of a first antenna array different from that shown in FIG. 5 according to an embodiment of this application;

FIG. 15 is a diagram of a structure of a second antenna array different from that shown in FIG. 5 according to an embodiment of this application; and

FIG. 16 is a diagram of a structure of a third antenna array different from that shown in FIG. 5 according to an embodiment of this application.

### Description of reference numerals:

100: antenna array;

10: stripline; 11: stripline inner conductor; 12: cavity; 121: accommodation cavity; 122: cavity segment; 13: movable member;

20: radiating element; 21: radiating portion; 211: layer structure; 22: feeding portion; 221: feeding inner core; 222: feeding outer conductor;

23: first radiating element; 24: second radiating element; 25: third radiating element; 26: fourth radiating element; 27: fifth radiating element;

30: second radome;

41: first transmission member; 411: transmission shaft; 412: active gear; 413: driven gear; 42: second transmission member; 43: third transmission member;

50: driving member;

60: first radome;

200: communication device; 210: base station antenna; 220: pole; and 230: antenna adjustment bracket.

### DESCRIPTION OF EMBODIMENTS

Terms used in implementations of this application are only used to explain specific embodiments of this application, but are not intended to limit this application.

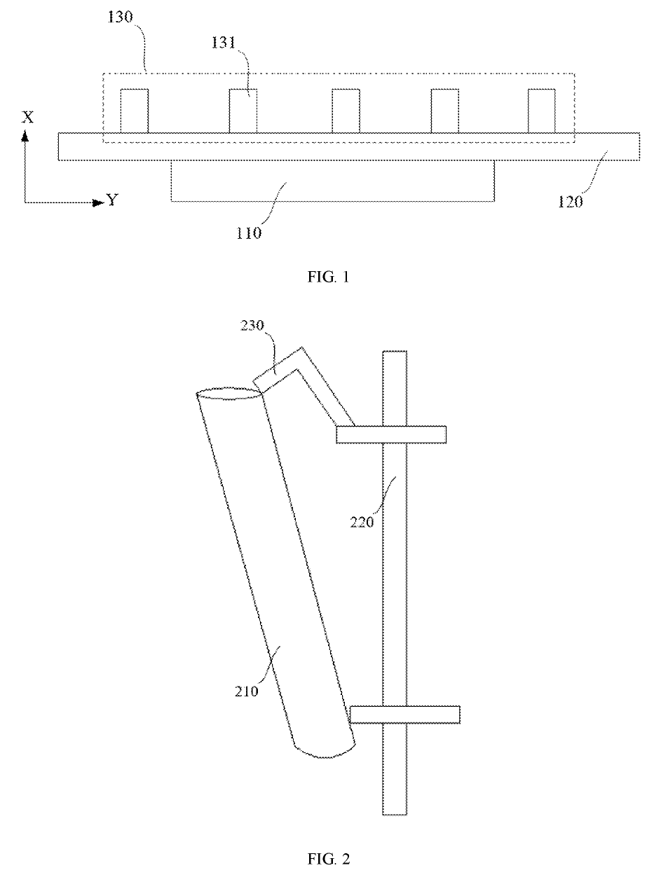

FIG. 1 is a diagram of a structure of a base station antenna in a related technology. As shown in FIG. 1, the base station antenna includes a reflection panel 120, a phase shifter 110, and a plurality of array antennas 130. Each array antenna 130 includes a plurality of radiating elements 131. The phase shifter 110 and the array antenna 130 are disposed on two opposite sides of the reflection panel 120. The phase shifter 110 is electrically connected to the radiating element 131 through a coaxial cable. A phase of the radiating element 131 may be adjusted by using the phase shifter 110 to implement beam downtilt, thereby achieving an objective of adjusting a downtilt angle. The reflection panel 120 reflects an electromagnetic signal radiated by the radiating element 131 to implement directional radiation.

However, limited by the reflection panel 120, a weight of the base station antenna is relatively heavy. In addition, because a dielectric loss of the coaxial cable is relatively large, overall performance of the base station antenna deteriorates. In addition, an azimuth of a single array antenna 130 cannot be separately adjusted in a mechanical rotation manner. Therefore, a use requirement cannot be met.

In view of this, embodiments of this application provide a base station antenna 210 and a communication device 200 to separately adjust an azimuth of a single antenna array 100 in the base station antenna 210. In addition, when the reflection panel is removed, a radiating element 20 can perform directional radiation, so that not only a use requirement can be met, but also a weight of the base station antenna 210 can be reduced to implement a lightweight design. In addition, the radiating element 20 in the base station antenna 210 is separately electrically connected to the cavity 12 and the stripline inner conductor 11 in the stripline 10, so that a loss can be reduced, and overall performance of the base station antenna 210 can be ensured.

The communication device 200 provided in embodiments of this application may include but is not limited to a radar, a RAN node, or the like. In this embodiment of this application, an example in which a RAN node is the communication device 200 is used for description. The RAN node may be located in a base station subsystem (base bastion subsystem, BBS), a terrestrial radio access network (UMTS terrestrial radio access network, UTRAN), or an evolved terrestrial radio access network (evolved universal terrestrial radio access, E‐UTRAN), and is configured to cover a cell by using a radio magnetic signal, to implement communication between a terminal device and a wireless network. Specifically, the RAN node may be a base transceiver station (base transceiver station, BTS) in a global system for mobile communications (global system for mobile communications, GSM) or a code division multiple access (code division multiple access, CDMA) system, or may be a NodeB (NodeB, NB) in a wideband code division multiple access (wideband code division multiple access, WCDMA) system, or may be an evolved NodeB (evolved NodeB, eNB, or eNodeB) in a long term evolution (long term evolution, LTE) system, or may be a radio controller in a cloud radio access network (cloud radio access network, CRAN) scenario, or may be an open radio access network (open radio access network, open RAN, O-RAN or ORAN) architecture. Alternatively, the RAN node may be a relay station, an access point, a vehicle-mounted device, a wearable device, a gNodeB (gNodeB or gNB) in a new radio (new radio, NR) system, a base station in a future evolved network, or the like. This is not limited in embodiments of this application.

In a possible scenario, the RAN node may be a base station (base station), an evolved NodeB (evolved NodeB, eNodeB), an access point (access point, AP), a transmission reception point (transmission reception point, TRP), a next generation NodeB (next generation NodeB, gNB), a next-generation base station in a 6^{th} generation (6^{th} generation, 6G) mobile communication system, a base station in a future mobile communication system, an access node in a Wi-Fi system, or the like. The RAN node may be a macro base station (for example, 110a in FIG. 1), a micro base station or an indoor station (for example, 110b in FIG. 1), a relay node or a donor node, or a radio controller in a CRAN scenario. Optionally, the RAN node may alternatively be a server, a wearable device, a vehicle, a vehicle-mounted device, or the like. For example, an access network device in a vehicle to everything (vehicle to everything, V2X) technology may be a road side unit (road side unit, RSU).

In another possible scenario, a plurality of RAN nodes coordinate to assist a terminal in implementing radio access, and different RAN nodes separately implement some functions of a base station. For example, the RAN node may be a central unit (central unit, CU), a distributed unit (distributed unit, DU), a CU-control plane (control plane, CP), a CU-user plane (user plane, UP), or a radio unit (radio unit, RU). The CU and the DU may be separately disposed, or may be included in a same network element, for example, a baseband unit (baseband unit, BBU). The RU may be included in a radio frequency device or a radio frequency unit, for example, included in a remote radio unit (remote radio unit, RRU), an active antenna unit (active antenna unit, AAU), or a remote radio head (remote radio head, RRH).

In different systems, the CU (or the CU-CP and the CU-UP), the DU, or the RU may alternatively have different names, but a person skilled in the art may understand meanings thereof. For example, in an ORAN system, the CU may also be referred to as an O-CU (open CU), the DU may also be referred to as an O-DU, the CU-CP may also be referred to as an O-CU-CP, the CU-UP may also be referred to as an O-CU-UP, and the RU may also be referred to as an O-RU. For ease of description, the CU, the CU-CP, the CU-UP, the DU, and the RU are used as examples for description in this application. Any one of the CU (or the CU-CP or the CU-UP), the DU, and the RU in this application may be implemented by using a software module, a hardware module, or a combination of a software module and a hardware module.

FIG. 2 is a diagram of a structure of a communication device according to an embodiment of this application. As shown in FIG. 2, the communication device 200 provided in this embodiment of this application includes a base station antenna 210, a pole 220, and an antenna adjustment bracket 230. One end of the base station antenna 210 is connected to the pole 220, and the other end of the base station antenna 210 is connected to a first end of the antenna adjustment bracket 230. A second end of the antenna adjustment bracket 230 is connected to the pole 220. A downtilt angle of the entire base station antenna 210 may be adjusted by using the antenna adjustment bracket 230, to adjust electromagnetic signal coverage of the base station antenna 210.

The base station antenna 210 provided in this embodiment of this application includes at least one antenna array 100. The at least one antenna array 100 includes at least one radiating element 20.

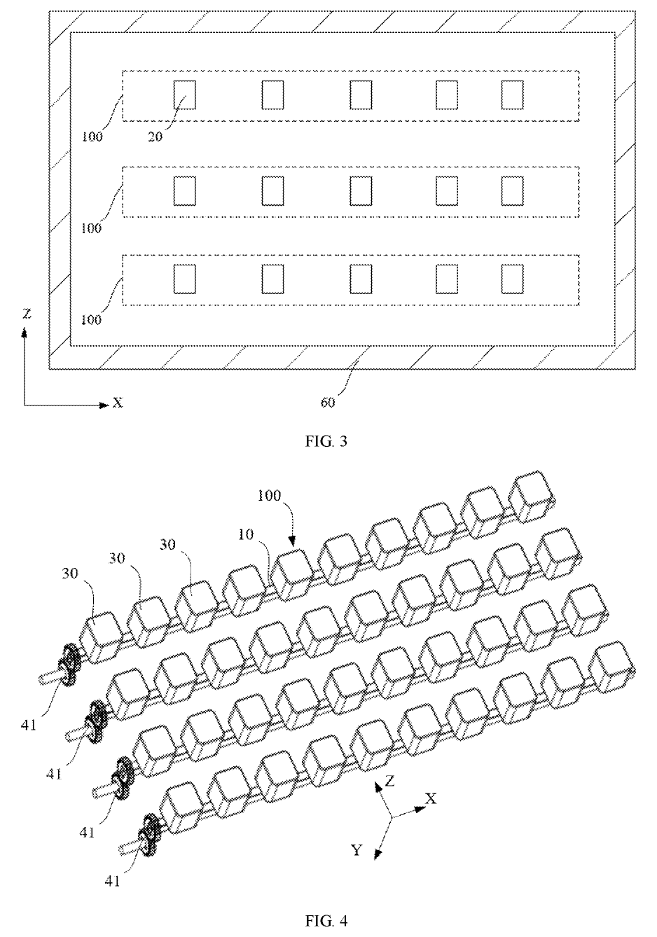

For example, as shown in FIG. 3, the base station antenna 210 includes three antenna arrays 100, and each antenna array 100 includes five radiating elements 20. Certainly, a quantity of antenna arrays 100 included in the base station antenna 210 may be more than or fewer than three, and a quantity of radiating elements 20 included in at least one antenna array 100 may be more than or fewer than five. FIG. 3 is a sectional view of a first base station antenna according to an embodiment of this application.

When the base station antenna 210 includes one antenna array 100, the antenna array 100 may include one or more radiating elements 20.

When the base station antenna 210 includes a plurality of antenna arrays 100, each antenna array 100 may include a plurality of radiating elements 20; or some of the plurality of antenna arrays 100 each include a plurality of radiating elements 20, and some other of the plurality of antenna arrays 100 each include one radiating element 20.

When the base station antenna 210 includes a plurality of antenna arrays 100 and each antenna array 100 includes a plurality of radiating elements 20, quantities of radiating elements 20 of the plurality of antenna arrays 100 may be the same, or quantities of radiating elements 20 of at least two of the plurality of antenna arrays 100 are different.

When the base station antenna 210 includes a plurality of antenna arrays 100, operating frequency bands of the plurality of antenna arrays 100 may be the same, or operating frequency bands of at least two antenna arrays 100 are different.

In this embodiment of this application, the radiating element 20 may also be referred to as an antenna element, an element, or the like, which is a basic unit constituting the antenna array 100, and can effectively radiate or receive an electromagnetic signal.

Still refer to FIG. 3. The base station antenna 210 may further include a first radome 60, and at least one antenna array 100 is disposed inside the first radome 60. The first radome 60 may protect the antenna array 100 from being affected by an external environment.

With reference to the accompanying drawings, the following describes an implementation of the base station antenna 210 provided in this embodiment of this application.

FIG. 4 is a diagram of a partial structure of a second base station antenna according to an embodiment of this application. FIG. 5 is a partial sectional view of a single antenna array in FIG. 4 in cooperation with a driving member. The base station antenna 210 provided in this embodiment of this application includes at least one antenna array 100. For example, as shown in FIG. 4, the base station antenna 210 includes four antenna arrays 100. Certainly, a quantity of antenna arrays 100 may be more than or fewer than four. The plurality of antenna arrays 100 are arranged side by side at intervals along a second direction (for example, a Z direction in FIG. 4). The at least one antenna array 100 includes a stripline 10 and at least one radiating element 20. For example, as shown in FIG. 4 and FIG. 5, the four antenna arrays 100 each include a stripline 10 and 10 radiating elements 20. Certainly, a quantity of antenna arrays 100 having a stripline 10 and at least one radiating element 20 may alternatively be more than or fewer than four, and a quantity of radiating elements 20 of the at least one antenna array 100 may alternatively be more than or fewer than 10. In a same antenna array 100, a plurality of radiating elements 20 are arranged side by side at intervals along a length direction (for example, an X direction in FIG. 4) of the stripline 10.

The second direction intersects and does not overlap either a first direction (for example, a Y direction in FIG. 4) or the length direction (for example, the X direction in FIG. 4) of the stripline 10. In this embodiment of this application, the first direction, the second direction, and the length direction of the stripline 10 are perpendicular to each other.

In this embodiment of this application, the base station antenna 210 includes a plurality of antenna arrays 100, and each antenna array 100 includes a stripline 10. However, in some possible implementations, some of the plurality of antenna arrays 100 of the base station antenna 210 include a stripline 10. For example, the base station antenna 210 includes four antenna arrays 100, and two of the four antenna arrays 100 include a stripline 10. Certainly, a quantity of antenna arrays 100 including the stripline 10 may be more than or fewer than two.

Still refer to FIG. 4 and FIG. 5. The at least one antenna array 100 further includes at least one second radome 30. For example, as shown in FIG. 4 and FIG. 5, the four antenna arrays 100 each include 10 second radomes 30. Certainly, a quantity of antenna arrays 100 including the second radome 30 may be more than or fewer than four, and a quantity of second radomes 30 of at least one of the four antenna arrays 100 may be more than or fewer than 10. In a same antenna array 100, a plurality of second radomes 30 are in one-to-one correspondence with a plurality of radiating elements 20, an opening of each second radome 30 faces the cavity 12 and is connected to the cavity 12, and each radiating element 20 is disposed inside a corresponding second radome 30. The second radome 30 may protect the radiating element 20 from being affected by an external environment.

A specific structure of the second radome 30 is not limited herein. For example, as shown in FIG. 4, the second radome 30 is a cuboid, the second radome 30 is of a tubular structure, and an opening of the tubular structure faces the stripline 10.

In an embodiment, the second radome 30 (not shown in the figure) may alternatively be removed from each antenna array 100 of the base station antenna 210.

In an embodiment, when the base station antenna 210 has a first radome 60 (not shown in the figure), the second radome 30 of the at least one antenna array 100 may alternatively be disposed inside the first radome 60. Certainly, when the second radome 30 is removed from the antenna array 100, the radiating element 20 of the at least one antenna array 100 may alternatively be disposed inside the first radome 60.

In this embodiment of this application, still refer to FIG. 5. The base station antenna 210 further includes a driving member 50. The driving member 50 is drivingly connected to the cavity 12 of the stripline 10, and is configured to output a driving force to drive the antenna array 100 to rotate around a rotation axis parallel to the length direction of the stripline 10.

Certainly, in a possible implementation, the base station antenna 210 may alternatively not include the driving member 50. In this case, the driving member 50 and the base station antenna 210 are two parallel components in the communication device 200.

A specific structure of the driving member 50 is not limited herein. For example, the driving member 50 may include a drive motor, and the drive motor is configured to output a driving force driving the antenna array 100 to rotate.

Still refer to FIG. 5. The driving member 50 is drivingly connected to the cavity 12 of the stripline 10. However, the driving member 50 may alternatively be indirectly drivingly connected to the cavity 12 of the stripline 10 through the second radome 30. Specifically, the second radome 30 is configured to receive the driving force output by the driving member 50 and transfer the driving force to the cavity 12, so that the cavity 12 drives the radiating element 20 and the second radome 30 that are disposed on the cavity 12 to rotate around the rotation axis together.

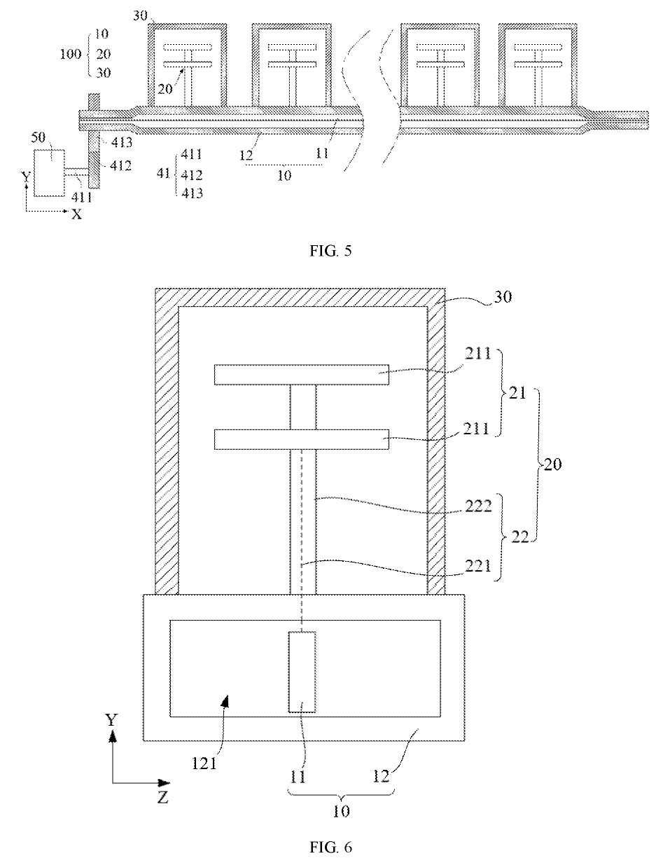

FIG. 6 is a partial sectional view of the antenna array in FIG. 5. With reference to FIG. 5, refer to FIG. 6. The stripline 10 of the at least one antenna array 100 includes a stripline inner conductor 11 and a cavity 12, and the stripline inner conductor 11 is disposed inside the cavity 12. In a same antenna array 100, a plurality of radiating elements 20 are fastened to an outer surface of the cavity 12. The cavity 12 is configured to drivingly connect to the driving member 50 and receive the driving force output by the driving member 50. When the cavity 12 receives the driving force, the antenna array 100 corresponding to the cavity 12 is configured to rotate around the rotation axis parallel to the length direction of the stripline 10, and an azimuth of the antenna array 100 may be separately adjusted.

It can be learned from FIG. 4 that the plurality of antenna arrays 100 are arranged side by side at intervals along the second direction. Therefore, rotation axes of any two antenna arrays 100 are parallel to each other.

It can be learned from FIG. 4 that there are a plurality of antenna arrays 100, and the cavity 12 of the at least one antenna array 100 is configured to receive a driving force, so that an azimuth of a single antenna array 100 can be adjusted. For example, cavities 12 of the plurality of antenna arrays 100 are all configured to receive the driving force, and an azimuth of any antenna array 100 may be adjusted flexibly. Alternatively, some cavities 12 of the plurality of antenna arrays 100 of the base station antenna 210 are configured to receive the driving force. For example, in an embodiment, the base station antenna 210 includes four antenna arrays 100, a cavity 12 of one antenna array 100 is configured to receive the driving force, and cavities 12 of the remaining three antenna arrays 100 do not receive the driving force.

In a possible implementation, it can be learned with reference to FIG. 4 that rotation directions of the plurality of antenna arrays 100 may be the same. For example, the plurality of antenna arrays 100 may all rotate clockwise or counterclockwise around the rotation axis. Certainly, rotation directions of some of the plurality of antenna arrays 100 may be the same. For example, in FIG. 4, rotation directions of two antenna arrays are the same, and rotation directions of the remaining two antenna arrays 100 are different from the rotation directions of the two antenna arrays 100. In this way, a corresponding use requirement can be met.

In a possible implementation, it can be learned with reference to FIG. 4 that at least two antenna arrays 100 in the base station antenna 210 rotate simultaneously. For example, in FIG. 4, two antenna arrays 100 rotate simultaneously, and the remaining two antenna array 100 do not rotate simultaneously with the two antenna arrays 100. Certainly, the plurality of antenna arrays 100 in the base station antenna 210 may alternatively not rotate simultaneously, in other words, the plurality of antenna arrays 100 rotate separately. Simultaneous rotation may be understood as that the plurality of antenna arrays 100 rotate at a same moment. In addition, non-simultaneous rotation may be understood as that only one antenna array 100 rotates at a same moment. In this way, an azimuth of the corresponding antenna array 100 may be adjusted based on a use requirement.

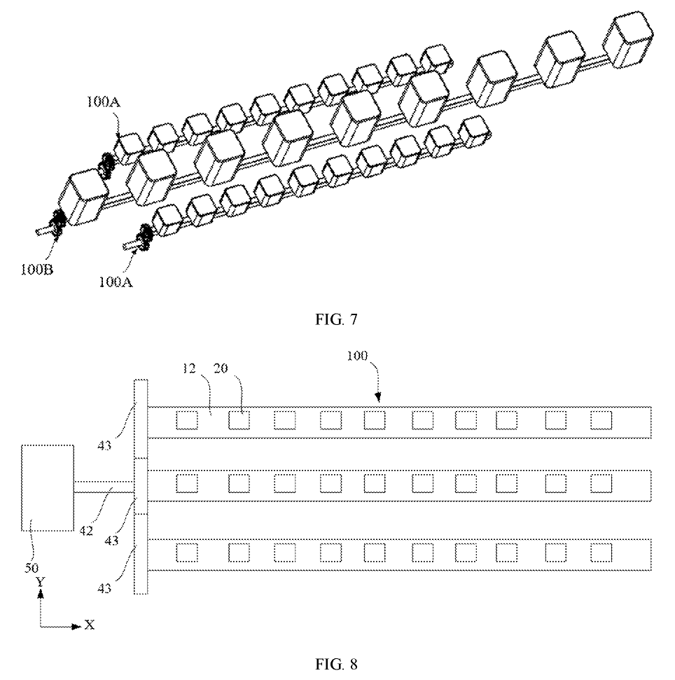

In a possible implementation, operating frequency bands of at least two of the plurality of antenna arrays 100 in the base station antenna 210 are different. For example, FIG. 7 is a diagram of a structure of a base station antenna having a plurality of operating frequency bands according to an embodiment of this application. In FIG. 7, an operating frequency band of two antenna arrays 100A in three antenna arrays 100 is a first frequency band, an operating frequency band of a remaining antenna array 100B is a second frequency band, and the first frequency band is different from the second frequency band. Certainly, operating frequency bands of the plurality of antenna arrays 100 in the base station antenna 210 are the same.

In conclusion, the plurality of antenna arrays 100 in the base station antenna 210 provided in this embodiment of this application may rotate simultaneously or at least two antenna arrays 100 rotate simultaneously, and/or rotation directions of at least two antenna arrays 100 are the same, and/or operating frequency bands of at least two antenna arrays 100 are different or operating frequency bands of the plurality of antenna arrays 100 are the same, to meet a user requirement.

In this embodiment of this application, how the driving member 50 drives the plurality of antenna arrays 100 to rotate is not limited herein.

For example, with reference to FIG. 4 and FIG. 5, the base station antenna 210 may further include a plurality of first transmission members 41. The plurality of first transmission members 41 are in one-to-one correspondence with the plurality of antenna arrays 100. The first transmission member 41 is configured to drivingly connect the driving member 50 and the cavity 12 of the corresponding antenna array 100. The driving member 50 is drivingly connected to the plurality of antenna arrays 100 through the plurality of first transmission members 41, so that not only a single antenna array 100 can rotate separately to flexibly adjust an azimuth of the single antenna array 100, but also a time at which the single antenna array 100 rotates can be controlled to meet a use requirement. In addition, difficulty in controlling whether the plurality of antenna arrays 100 simultaneously rotate can be reduced.

A quantity of driving members 50 is not limited herein. In an embodiment, one antenna array 100 may correspond to one driving member 50, and each driving member 50 drives the corresponding antenna array 100 to rotate. Alternatively, in an embodiment, one driving member 50 may correspond to at least two antenna arrays 100. For example, one driving member 50 drives two antenna arrays 100 to rotate.

A specific structure of the first transmission member 41 is not limited herein. For example, still refer to FIG. 4 and FIG. 5. Each first transmission member 41 includes a transmission shaft 411, an active gear 412, and a driven gear 413. The active gear 412 is sleeved on one end of the transmission shaft 411 and engaged with the driven gear 413. The driven gear 413 is sleeved on an outer wall of the cavity 12. An axis of the transmission shaft 411 is parallel to the length direction of the stripline 10, and the axis of the transmission shaft 411 may be located below or above the cavity 12 along the first direction. Certainly, the axis of the transmission shaft 411 may alternatively be disposed on one side of the cavity 12 along the second direction. The driving member 50 is drivingly connected to the transmission shaft 411, and the driving member 50 drives the transmission shaft 411 to rotate, so that the active gear 412 drives the driven gear 413 to rotate. The driven gear 413 drives the cavity 12 to rotate, so that the antenna array 100 rotates.

It should be noted that in addition to a gear transmission manner, the first transmission member 41 may be drivingly connected to the cavity 12 and the driving member 50 in a manner such as chain transmission, belt transmission, or rack transmission.

FIG. 8 is a diagram of a second structure that is different from that in FIG. 5 and in which a driving member is drivingly connected to an antenna array according to an embodiment of this application. A difference between FIG. 8 and FIG. 5 lies in that a base station antenna 210 may further include a second transmission member 42 and a plurality of third transmission members 43. The plurality of third transmission members 43 are in one-to-one correspondence with cavities 12 of a plurality of antenna arrays 100. Each third transmission member 43 is connected to the cavity 12 of the corresponding antenna array 100. Two adjacent third transmission members 43 are drivingly connected along a direction perpendicular to a length direction of a stripline 10. The second transmission member 42 is drivingly connected to a driving member 50 and a cavity 12 of one of the plurality of antenna arrays 100. For example, as shown in FIG. 8, there are three third transmission members 43, each antenna array 100 corresponds to one third transmission member 43, a cavity 12 of one of the three antenna arrays 100 is drivingly connected to the driving member 50 by using the second transmission member 42.

It should be noted that in addition to the cavity 12, the second transmission member 42 may further be drivingly connected to one of the plurality of third transmission members 43. In addition, the plurality of antenna arrays 100 may or may not rotate simultaneously. This is not limited herein. In addition, structures of the plurality of third transmission members 43 may be the same or different. This is not limited herein. A manner in which two adjacent third transmission members 43 are drivingly connected may include but is not limited to gear transmission, chain transmission, belt transmission, and the like.

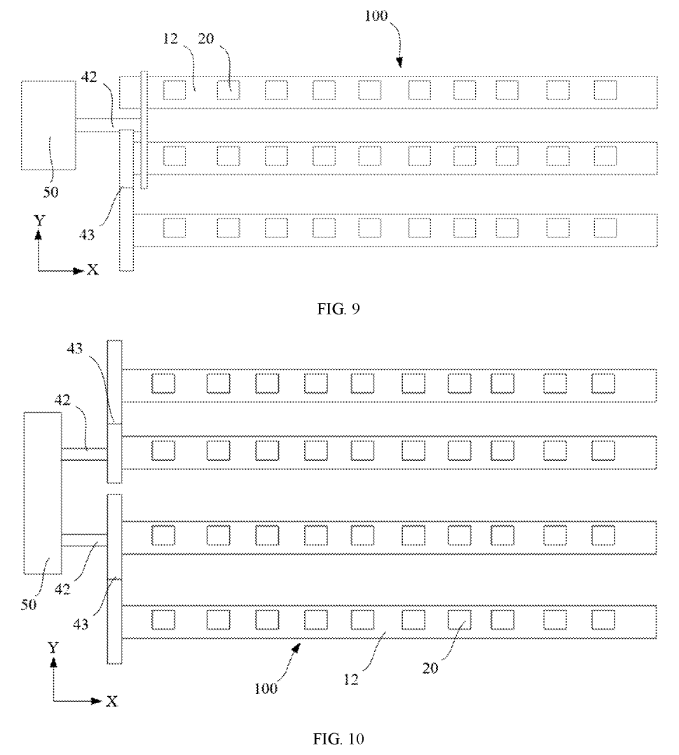

FIG. 9 is a diagram of a third structure in which a driving member is drivingly connected to a plurality of antenna arrays according to an embodiment of this application. A difference between FIG. 9 and FIG. 8 lies in that a base station antenna 210 may further include a second transmission member 42 and at least one third transmission member 43. One end of the second transmission member 42 is drivingly connected to a driving member 50. A second end and a third end of the second transmission member 42 are respectively drivingly connected to cavities 12 of two of a plurality of antenna arrays 100. A cavity 12 of each of the remaining antenna arrays 100 in the plurality of antenna arrays 100 is drivingly connected to the cavity 12 of either of the two antenna arrays 100 by using a third transmission member 43. For example, as shown in FIG. 9, the second transmission member 42 is drivingly connected to the driving member 50 and the cavities 12 of the two antenna arrays 100, and the cavity 12 of the remaining antenna array 100 is drivingly connected to the cavity 12 of one of the two antenna arrays 100 by using a third transmission member 43.

FIG. 10 is a diagram of a fourth structure in which a driving member is drivingly connected to a plurality of antenna arrays according to an embodiment of this application. A difference between FIG. 10 and FIG. 8 lies in that a base station antenna 210 may include a plurality of second transmission members 42 and a plurality of third transmission members 43. The plurality of antenna arrays 100 are divided into at least two groups, each group includes a plurality of antenna arrays 100, and each group corresponds to one second transmission member 42. In a same group, cavities 12 of two adjacent antenna arrays 100 are drivingly connected along a second direction by using a third transmission member 43. A cavity 12 of an antenna array 100 in each group is drivingly connected to the driving member 50 by using a corresponding second transmission member 42.

It should be noted that in addition to the cavity 12, the second transmission member 42 may further be indirectly drivingly connected to the cavity 12 through the third transmission member 43.

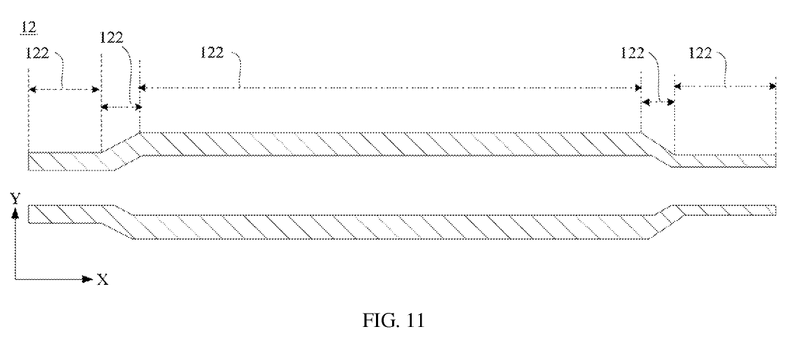

FIG. 11 is a transverse sectional view of a cavity in FIG. 5. In a possible implementation, as shown in FIG. 11, a cavity 12 in at least one antenna array 100 includes a plurality of cavity segments 122 extending along a length direction of a stripline 10. In a same cavity 12, areas of radial cross-sections of at least two cavity segments 122 along the length direction of the stripline 10 are different. The radial cross-section of the cavity segment 122 is perpendicular to the length direction of the stripline 10. Because the cavity 12 includes at least two cavity segments 122 with different areas of radial cross-sections, a weight of the cavity 12 is reduced, so that a weight of the antenna array 100 can be reduced, and further a weight of the base station antenna 210 can be reduced.

In this embodiment of this application, that the areas of the radial cross-sections of the at least two cavity segments 122 are different may be understood as that wall thicknesses of the at least two cavity segments 122 are different, or may be understood as that inner diameters and/or outer diameters of the at least two cavity segments 122 are different.

A specific quantity of antenna arrays 100 including cavities 12 of a plurality of cavity segments 122 is not limited herein. In an embodiment, a cavity 12 of each antenna array 100 includes at least two cavity segments 122 having different areas of radial cross-sections. Alternatively, in an embodiment, cavities 12 of some of the plurality of antenna arrays 100 include at least two cavity segments 122 having different areas of radial cross-sections.

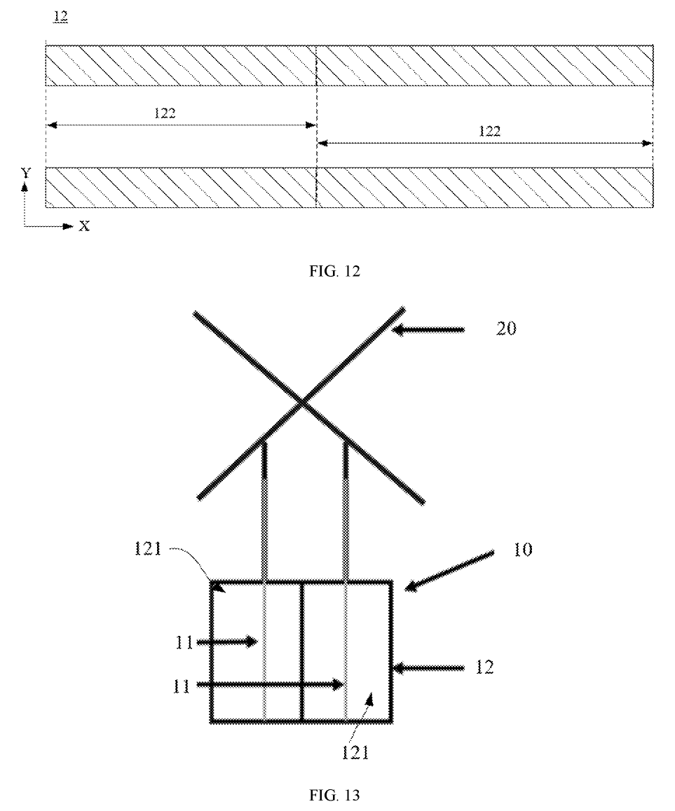

Certainly, in addition to a plurality of cavity segments 122 having different areas of radial cross-sections, a cavity 12 may alternatively include a plurality of cavity segments 122 having same areas of radial cross-sections. For example, as shown in FIG. 12, the cavity 12 includes two cavity segments 122. FIG. 12 is a transverse sectional view of another cavity according to an embodiment of this application. It may be understood that the cavity 12 including the plurality of cavity segments 122 having the same areas of the radial cross-sections may be understood as a cavity structure having a same inner diameter and/or outer diameter along a length direction of the cavity 12.

In some embodiments, the plurality of cavity segments 122 of the cavity 12 may be of an integrated structure; or in some embodiments, the cavity 12 may be formed by splicing the plurality of cavity segments 122.

In a possible implementation, with reference to FIG. 6, a cavity 12 of at least one antenna array 100 is configured to define at least one accommodation cavity 121. For example, as shown in FIG. 4, cavities 12 of four antenna arrays 100 each define a plurality of accommodation cavities 121. Certainly, a quantity of antenna arrays 100 having a plurality of accommodation cavities 121 may be more than or fewer than four. The stripline 10 of the at least one antenna array 100 includes at least one stripline inner conductor 11. In the same antenna array 100, the at least one accommodation cavity 121 is in one-to-one correspondence with the at least one stripline inner conductor 11, and each stripline inner conductor 11 is disposed inside the corresponding accommodation cavity 121. In the same antenna array 100, when the cavity 12 defines a plurality of accommodation cavities 121, the plurality of accommodation cavities 121 are arranged side by side along a direction perpendicular to the length direction of the stripline 10, and two adjacent accommodation cavities 121 share one side wall. In this way, the stripline 10 may be electrically connected to the radiating element 20 having at least one polarization direction. In addition, when there are a plurality of accommodation cavities 121, two adjacent accommodation cavities 121 are separated by using a side wall, so that electromagnetic interference can be avoided during electromagnetic signal transmission, and an electromagnetic signal transmission effect can be improved.

The accommodation cavity 121 runs through two opposite ends along the length direction of the stripline 10, in other words, the accommodation cavity 121 may be similar to an interior of a pipe open at two ends, that is, the accommodation cavity 121 is of a hollow structure. Alternatively, the cavity 12 may be understood as a tubular structure open at two ends.

It should be noted that when there are a plurality of antenna arrays 100, in addition to that a cavity 12 of each antenna array 100 defines a plurality of accommodation cavities 121, in some possible implementations, cavities 12 of some of the plurality of antenna arrays 100 may define a plurality of accommodation cavities 121, and cavities 12 of some other antenna arrays 100 define one accommodation cavity 121. Alternatively, in some possible implementations, a cavity 12 of each of the plurality of antenna arrays 100 defines one accommodation cavity 121.

In some possible implementations, a quantity of accommodation cavities 121 defined by the cavity 12 may be determined based on a polarization direction of the radiating element 20. This is not limited herein.

In an embodiment, when the radiating element 20 is a single-polarized radiating element, a cavity 12 of an antenna array 100 having the single-polarized radiating element is configured to define one accommodation cavity 121, and one stripline inner conductor 11 is disposed inside the accommodation cavity 121. A first end and a second end of the single-polarized radiating element are respectively electrically connected to the cavity 12 and the stripline inner conductor 11, for example, as shown in FIG. 6.

Alternatively, in an embodiment, when the radiating element 20 is a dual-polarized radiating element, a cavity 12 of an antenna array 100 having the dual-polarized radiating element is configured to define two accommodation cavities 121, the two the accommodation cavities 121 are arranged side by side along a direction perpendicular to the length direction of the stripline 10, and the two accommodation cavities 121 share one side wall. In other words, the cavity 12 of the at least one antenna array 100 defines two accommodation cavities 121 separated by using an inner wall. In a same antenna array 100, one stripline inner conductor 11 is disposed inside each accommodation cavity 121. A first end and a second end of the dual-polarized radiating element are separately electrically connected to the cavity 12. A third end and a fourth end of the dual-polarized radiating element are respectively electrically connected to two stripline inner conductors 11 disposed inside two accommodation cavities 121, for example, as shown in FIG. 13. FIG. 13 is a diagram of a structure of an antenna array of a third base station antenna according to an embodiment of this application.

Dual polarization of a dual-polarized radiating element may include but is not limited to horizontal, vertical, ±45°, and the like. In addition, in this embodiment of this application, an example in which the dual-polarized radiating element is the radiating element 20 is used for description.

It should be noted that when there are a plurality of antenna arrays 100, polarization directions of radiating elements 20 of the plurality of antenna arrays 100 may be the same or different. In addition, when the antenna array 100 includes a plurality of radiating elements 20, polarization directions of the plurality of radiating elements 20 may be the same or different.

In a possible implementation, a stripline 10 of at least one antenna array 100 may further include a movable member 13 (not shown in the figure). The movable member 13 is disposed inside a cavity 12 and is configured to move along a length direction of the stripline 10 relative to a stripline inner conductor 11 to change a phase of an electromagnetic signal radiated by the radiating element 20, thereby implementing a phase modulation function, and further adjusting a downtilt angle of the antenna array 100.

A specific quantity of antenna arrays 100 having a movable member 13 is not limited herein. For example, in this embodiment of this application, a stripline 10 of each antenna array 100 includes a movable member 13, and a downtilt angle of any one of the plurality of antenna arrays 100 may be flexibly adjusted. Alternatively, in some embodiments, some of the plurality of antenna arrays 100 have a movable member 13.

Because the cavity 12 is configured to define at least one accommodation cavity 121 for accommodating a stripline inner conductor 11, the stripline 10 includes at least one movable member 13. The at least one movable member 13 is in one-to-one correspondence with the at least one accommodation cavity 121. Each movable member 13 is disposed inside the corresponding accommodation cavity 121. For example, a stripline 10 of at least one of the plurality of antenna arrays 100 includes two accommodation cavities 121 and two movable members 13, and each movable member 13 is disposed inside the corresponding accommodation cavity 121.

A specific structure of the movable member 13 is not limited herein. In an embodiment, the movable member 13 includes a dielectric member configured to slide relative to the stripline inner conductor 11 along the length direction of the stripline 10, so that an equivalent dielectric constant between the stripline inner conductor 11 and the cavity 12 changes to achieve a phase shift purpose. Alternatively, in an embodiment, the movable member 13 includes a metal member configured to slide along the length direction of the stripline 10 and configured to couple to the stripline inner conductor 11, so that a transmission path length of an electromagnetic signal can be changed to achieve a phase shift purpose.

In this embodiment of this application, still refer to FIG. 6. In a same antenna array 100, at least one radiating element 20 includes a radiating portion 21 and a feeding portion 22. For example, as shown in FIG. 4, in a same antenna array 100, 10 radiating elements 20 each include a radiating portion 21 and a feeding portion 22. Certainly, a quantity of radiating elements 20 having a radiating portion 21 and a feeding portion 22 may be more than or fewer than 10. A first end of the feeding portion 22 is fastened to an outer surface of the cavity 12. The radiating portion 21 is fastened to a second end of the feeding portion 22 and is separately electrically connected to the stripline inner conductor 11 and the cavity 12 through the feeding portion 22. In this way, not only the radiating portion 21 can be fastened to the outer surface of the cavity 12 to simplify a structure of the antenna array 100, but also the radiating portion 21 can be separately electrically connected to the cavity 12 and the stripline inner conductor 11 to reduce a loss.

In this embodiment of this application, each of the plurality of radiating elements 20 of the antenna array 100 includes a radiating portion 21 and a feeding portion 22. However, in some possible implementations, some of the plurality of radiating elements 20 of the antenna array 100 may include a radiating portion 21 and feeding portion 22. For example, two of four radiating elements 20 of the antenna array 100 include a radiating portion 21 and a feeding portion 22.

In this embodiment of this application, a specific structure of the radiating part 21 is not limited herein.

For example, still refer to FIG. 6. The radiating portion 21 includes a plurality of layer structures 211 arranged side by side at intervals along the first direction, and the plurality of layer structures 211 are configured to directionally radiate an electromagnetic signal along the first direction away from the stripline 10. The first direction intersects and does not overlap the length direction of the stripline 10. The radiating portion 21 including the plurality of layer structures 211 directionally radiates an electromagnetic signal to a corresponding region, so that not only a use requirement can be met, but also a reflection panel in a related technology can be removed to reduce a weight of base station antenna 210 to implement a lightweight design.

When the reflection panel is removed, how the radiating portion 21 implements directional radiation is not limited herein. In an embodiment, a layer structure 211 that is in the plurality of layer structures 211 of the radiating portion 21 and that is closest to the stripline 10 may be configured to reflect an electromagnetic signal radiated by a remaining layer structure 211, that is, a layer structure 211 closest to the stripline 10 functions as a reflection panel. In an embodiment, each layer structure 211 in the radiating portion 21 is configured to radiate an electromagnetic signal. Electromagnetic signals radiated by all layer structures 211 are superposed, so that the radiating portion 21 directionally radiates the electromagnetic signal.

In a same radiating portion 21, structures of all layer structures 211 may be the same or different. This is not limited herein. In addition, a specific structure of the layer structure 211 is not limited herein either.

It should be noted that when the antenna array 100 includes a plurality of radiating portions 21, in addition to that each radiating portion 21 includes a plurality of layer structures 211, in some possible implementations, some of the plurality of radiating portions 21 include a plurality of layer structures 211, in other words, in the same antenna array 100, there are at least two structures of the radiating portions 21.

Still refer to FIG. 5. At least one antenna array 100 includes a plurality of radiating elements 20. For example, as shown in FIG. 4, the four antenna arrays 100 each include a plurality of radiating elements 20. Certainly, a quantity of antenna arrays 100 having a plurality of radiating elements 20 may alternatively be more than or fewer than four. In a same antenna array 100, a plurality of radiating elements 20 are arranged side by side at intervals along a length direction of the stripline 10. In other words, in a same antenna array 100, there is a gap between two adjacent radiating elements 20 along the length direction of the stripline 10. Therefore, there is a gap between layer structures 211 of the two adjacent radiating elements 20, and the layer structures 211 of the two adjacent radiating elements 20 are independent of each other.

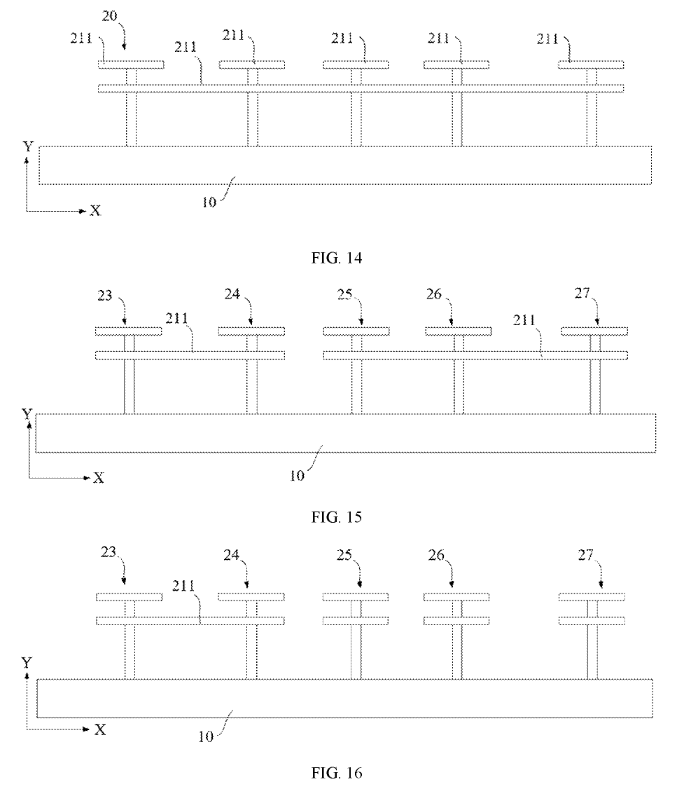

FIG. 14 is a diagram of a structure of a first antenna array different from that shown in FIG. 5 according to an embodiment of this application. In a possible implementation, when least one antenna array 100 includes a plurality of radiating elements 20, in a same antenna array 100, the plurality of radiating elements 20 are arranged side by side along a length direction of a stripline 10. Two adjacent layer structures 211 are an integrated structure. The two adjacent layer structures 211 respectively belong to two adjacent radiating elements 20 in the at least two radiating elements 20.

Still refer to FIG. 14. Two adjacent layer structures 211 are layer structures 211 that are in radiating portions 21 and that are closer to the stripline 10 along the first direction. However, in some embodiments, two adjacent layer structures 211 may alternatively be layer structures 211 that are in the radiating portion 21 and that are far away from the stripline 10 along the first direction.

Still refer to FIG. 14. Two adjacent layer structures 211 are disposed at an equal height relative to the stripline 10 along the first direction. However, two adjacent layer structures 211 may alternatively be disposed at a non-equal height relative to the stripline 10 along the first direction.

Still refer to FIG. 14. That the two adjacent layer structures 211 are an integrated structure may be understood as that radiating portions 21 of the two adjacent radiating elements 20 share a same layer structure 211. In addition, in a same antenna array 100, a quantity of radiating elements 20 sharing a same layer structure 211 may be all (as shown in FIG. 14) or some (for example, as shown in FIG. 15 or FIG. 16).

In an embodiment, an antenna array 100 includes five radiating elements 20, and the five radiating elements 20 share a same layer structure 211, as shown in FIG. 14.

FIG. 15 is a diagram of a structure of a second antenna array different from that shown in FIG. 5 according to an embodiment of this application. In an embodiment, as shown in FIG. 15, the antenna array 100 includes five radiating elements 20. The five radiating elements 20 include a first radiating element 23, a second radiating element 24, a third radiating element 25, a fourth radiating element 26, and a fifth radiating element 27. The first radiating element 23 and the second radiating element 24 share one layer structure 211. The third radiating element 25, the fourth radiating element 26, and the fifth radiating element 27 share a same layer structure 211.

FIG. 16 is a diagram of a structure of a third antenna array different from that shown in FIG. 5 according to an embodiment of this application. In an embodiment, as shown in FIG. 16, the antenna array 100 includes five radiating elements. The five radiating elements include a first radiating element 23, a second radiating element 24, a third radiating element 25, a fourth radiating element 26, and a fifth radiating element 27. The first radiating element 23 and the second radiating element 24 share one layer structure 211.

In conclusion, in a same antenna array 100, a plurality of radiating elements 20 are arranged at intervals or radiating portions 21 of at least two radiating elements 20 share a same layer structure 211, so that an electromagnetic signal can be radiated to a corresponding region, thereby meeting a use requirement. However, when radiating portions 21 of at least two radiating elements 20 in a same antenna array 100 are independent of each other, the weight of the base station antenna 210 can be further reduced, thereby implementing an ultimate lightweight design.

In this embodiment of this application, still refer to FIG. 6. The feeding portion 22 includes a feeding inner core 221 and a feeding outer conductor 222. A first end of the feeding outer conductor 222 is fastened to the outer surface of the cavity 12 and is electrically connected to the cavity 12. The radiating portion 21 is connected to a second end of the feeding outer conductor 222 and is electrically connected to the feeding outer conductor 222. The radiating portion 21 is electrically connected to the stripline inner conductor 11 through the feeding inner core 221. In this way, not only the radiating portion 21 can be fastened to the outer surface of the cavity 12, but also the radiating portion 21 can be separately electrically connected to the stripline inner conductor 11 and the cavity 12, thereby implementing a low-loss design.

It should be noted that a connection manner in which the feeding inner core 221 is electrically connected to the radiating portion 21 may be an electrical connection in which physical contact exists or a coupling connection in which physical contact does not exist. In other words, the feeding inner core 221 may be directly electrically connected to or coupled to the radiating portion 21.

A specific structure of the feeding outer conductor 222 is not limited herein. In an embodiment, the feeding outer conductor 222 may be of a hollow structure, and the feeding inner core 221 is disposed inside the feeding outer conductor 222, so that compactness of the radiating element 20 can be improved.

In the descriptions of embodiments of this application, it should be noted that, unless otherwise clearly specified and limited, the term "mounting", "connection to", or "connection" should be understood in a broad sense, for example, may be fastening, or may be an indirect connection through an intermediate medium, or may be an internal communication between two elements or an interaction relationship between two elements. A person of ordinary skill in the art may understand specific meanings of the foregoing terms in embodiments of this application based on specific cases.

In embodiments of this application, it is implied that an apparatus or element in question needs to have a particular orientation, or needs to be constructed and operated in a particular orientation, and therefore cannot be construed as a limitation on embodiments of this application. In the description of embodiments of this application, unless otherwise exactly and specifically ruled, "a plurality of" means two or more than two.

In the specification, claims, and accompanying drawings of embodiments of this application, the terms "first", "second", "third", "fourth", and the like (if existent) are intended to distinguish between similar objects but do not necessarily indicate a specific order or sequence. It may be understood that data used in such a way is interchangeable in proper circumstances, so that embodiments of this application described herein can be implemented in other sequences than the sequence illustrated or described herein. In addition, the terms "include" and "have" and any other variants thereof are intended to cover the non-exclusive inclusion. For example, a process, method, system, product, or device that includes a series of steps or units is not necessarily limited to those expressly listed steps or units, but may include other steps or units not expressly listed or inherent to such a process, method, product, or device.

The term "a plurality of" in this specification refers to two or more. The term "and/or" in this specification describes only an association relationship for describing associated objects and represents that three relationships may exist. For example, A and/or B may represent the following three cases: Only A exists, both A and B exist, and only B exists. In addition, the character "/" in this specification usually indicates an "or" relationship between associated objects, and the character "/" in a formula usually indicates a "divisible" relationship between associated objects.

It may be understood that various numbers in embodiments of this application are merely used for differentiation for ease of description, and are not used to limit the scope of embodiments of this application.

It should be understood that sequence numbers of the foregoing processes do not mean execution sequences in embodiments of this application. The execution sequences of the processes should be determined based on functions and internal logic of the processes, and should not be construed as any limitation on the implementation processes of embodiments of this application.

1. A base station antenna, comprising at least one antenna array, wherein the at least one antenna array comprises a stripline and at least one radiating element;
the stripline comprises a stripline inner conductor and a cavity that is configured to accommodate the stripline inner conductor;
the at least one radiating element is fastened to an outer surface of the cavity; and
the cavity in the at least one antenna array is configured to receive a driving force output by a driving member, and when the cavity receives the driving force, the antenna array corresponding to the cavity rotates around a rotation axis parallel to a length direction of the stripline.

2. The base station antenna according to claim 1, wherein the at least one radiating element comprises a radiating portion separately electrically connected to the stripline inner conductor and the cavity, the radiating portion comprises a plurality of layer structures arranged side by side at intervals along a first direction, the plurality of layer structures are configured to directionally radiate an electromagnetic signal along the first direction away from the stripline, and the first direction intersects and does not overlap the length direction of the stripline.

3. A base station antenna, comprising at least one antenna array, wherein the at least one antenna array comprises a stripline and at least one radiating element;
the at least one radiating element is fastened to an outer surface of the stripline; and
the at least one radiating element comprises a radiating portion electrically connected to the stripline, the radiating portion comprises a plurality of layer structures arranged side by side at intervals along a first direction, the plurality of layer structures are configured to directionally radiate an electromagnetic signal along the first direction away from the stripline, and the first direction intersects and does not overlap a length direction of the stripline.

4. The base station antenna according to claim 3, wherein the stripline comprises a cavity and a stripline inner conductor that is disposed inside the cavity and that extends along the length direction of the stripline; and
in the same the antenna array, the at least one radiating element is connected to an outer surface of the cavity, and the radiating portion of the at least one radiating element is separately electrically connected to the cavity and the stripline inner conductor.

5. The base station antenna according to claim 4, wherein the cavity of the at least one antenna array is configured to receive a driving force output by a driving member; and
when the cavity receives the driving force, the antenna array corresponding to the cavity rotates around a rotation axis parallel to the length direction of the stripline.

6. The base station antenna according to claim 3, wherein the at least one antenna array comprises a plurality of radiating elements; and
in the same antenna array, the plurality of radiating elements are arranged side by side at intervals along the length direction of the stripline; or
in the same antenna array, the plurality of radiating elements are arranged side by side along the length direction of the stripline, two adjacent layer structures are an integrated structure, and the two adjacent layer structures respectively belong to two adjacent radiating elements in at least two radiating elements.

7. The base station antenna according to claim 4, wherein the at least one radiating element further comprises a feeding portion, a first end of the feeding portion is fastened to the outer surface of the cavity, and the radiating portion is fastened to a second end of the feeding portion and is separately electrically connected to the stripline inner conductor and the cavity through the feeding portion.

8. The base station antenna according to claim 7, wherein the feeding portion comprises a feeding inner core and a feeding outer conductor, a first end of the feeding outer conductor is fastened to the outer surface of the cavity and is electrically connected to the cavity, the radiating portion is connected to a second end of the feeding outer conductor and is electrically connected to the feeding outer conductor, and the radiating portion is electrically connected to the stripline inner conductor through the feeding inner core.

9. The base station antenna according to claim 4, wherein the cavity in the at least one antenna array comprises a plurality of accommodation cavity segments extending along the length direction of the stripline; and
in the same cavity, areas of radial cross-sections of at least two accommodation cavity segments are different along the length direction of the stripline, and the radial cross-section of the accommodation cavity segment is perpendicular to the length direction of the stripline.

10. The base station antenna according to claim 4, wherein the cavity in the at least one antenna array is configured to define at least one accommodation cavity, and the stripline of the at least one antenna array comprises at least one stripline inner conductor;
in the same antenna array, the at least one accommodation cavity is in one-to-one correspondence with the at least one stripline inner conductor, and the stripline inner conductor is disposed inside the corresponding accommodation cavity; and
when the cavity defines a plurality of accommodation cavities, the plurality of accommodation cavities are arranged side by side along a direction perpendicular to the length direction of the stripline, and two adjacent accommodation cavities share one side wall.

11. The base station antenna according to claim 10, wherein the stripline of the at least one antenna array further comprises at least one movable member, the at least one movable member is in one-to-one correspondence with the at least one accommodation cavity, and each movable member is disposed inside the corresponding accommodation cavity; and
the movable member comprises a dielectric member configured to slide relative to the stripline inner conductor along the length direction of the stripline; or
the movable member comprises a metal member configured to slide along the length direction of the stripline and configured to couple to the stripline inner conductor.

12. The base station antenna according to claim 10, wherein the radiating element is a single-polarized radiating element or a dual-polarized radiating element; and
when the radiating element is the single-polarized radiating element, the single-polarized radiating element is configured to separately electrically connect to the cavity and one stripline inner conductor; or
when the radiating element is the dual-polarized radiating element, the dual-polarized radiating element is configured to separately electrically connect to the cavity and two stripline inner conductors.

13. The base station antenna according to claim 5, wherein the base station antenna comprises a plurality of antenna arrays, rotation axes of any two antenna arrays are parallel to each other, and rotation directions of at least two antenna arrays are the same.

14. The base station antenna according to claim 5, wherein the base station antenna comprises the plurality of antenna arrays; and
the at least two antenna arrays rotate simultaneously; or
the plurality of antenna arrays do not rotate simultaneously.

15. The base station antenna according to claim 5, wherein the base station antenna comprises the plurality of antenna arrays; and
operating frequency bands of the at least two antenna arrays are different; or
operating frequency bands of the plurality of antenna arrays are the same.

16. The base station antenna according to claim 13, wherein the base station antenna further comprises a plurality of first transmission members, the plurality of first transmission members are in one-to-one correspondence with the plurality of antenna arrays, and the first transmission member is configured to drivingly connect the driving member and the cavity of the corresponding antenna array.

17. The base station antenna according to claim 16, wherein the base station antenna further comprises the driving member, the driving member is drivingly connected to the cavity of the at least one antenna array, and the driving member is configured to drive the at least one antenna array to rotate around the rotation axis.

18. The base station antenna according to claim 5, wherein the base station antenna comprises the plurality of antenna arrays, the plurality of antenna arrays are arranged side by side at intervals along a second direction, and the second direction intersects and does not overlap either the first direction or the length direction of the stripline.

19. A communication device, comprising the base station antenna
comprising at least one antenna array, wherein the at least one antenna array comprises a stripline and at least one radiating element;
the stripline comprises a stripline inner conductor and a cavity that is configured to accommodate the stripline inner conductor;
the at least one radiating element is fastened to an outer surface of the cavity; and
the cavity in the at least one antenna array is configured to receive a driving force output by a driving member, and when the cavity receives the driving force, the antenna array corresponding to the cavity rotates around a rotation axis parallel to a length direction of the stripline.
